(19) United States
(12) Patent Application Publication
(10) Pub. No.: US 2006/0194594 A1
(43) Pub. Date: Aug. 31, 2006

(54) Location services in a communications system

(75) Inventors: Ville Ruutu, Espoo (FI); Jarko Niemenmaa, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/144,019

(22) Filed: Jun. 3, 2005

(30) Foreign Application Priority Data
Feb. 25, 2005 (EP) 0503927.6

(51) Int. Cl. H04M 11/00

(52) U.S. Cl. 455/456.5; 455/456.1

(57) ABSTRACT

A user equipment is located in a communication system by a method. The user equipment communicates on a user plane to a network element information that relates to a communication channel between the user equipment and a node of the communication system.

### BACKGROUND OF THE INVENTION

1. Field of the Invention

The present disclosure relates to location services in a communications system.

2. Description of the Related Art

A communications system can be seen as a facility that enables communication sessions between two or more entities such as user equipment and/or other nodes. A communications system typically operates in accordance with a given standard or specification which sets out what the various entities associated with the system are permitted to do and how that should be achieved. For example, the standard or specification may define if a user equipment is provided with a circuit switched service or a packet switched service or both.

A communications system needs to be able to provide various different functions in order be able to operate. These functions can be divided in different categories. A category comprises functions that relate to the actual carrying of the communication such as voice or multimedia or other data content in the system. Another category can be seen as being formed by control or management functions such as the control of various services and the actual communication. Signalling of messages associated with different functions is thus understood as being implemented on different planes. For example, control messages are communicated on a control plane and the actual communication is then transported on a user plane. The communication on the user plane is supported the signalling of the control messages on the control plane. In general terms, user plane communications can be seen as an overlay solution where a data connection between a relevant network element, for example a server with an Internet Protocol address and a user equipment, is provided for communication of content while communication of control information is handled on the control plane.

Communication systems proving wireless communication for user equipment are known. These systems are commonly referred to as mobile systems, although in certain systems the mobility may be restricted to substantially small areas. An example of the mobile systems is the public land mobile network (PLMN). Another example is a mobile system that is based, at least partially, on use of communication satellites. Mobile communications may also be provided by means of other types of systems, such as by means of wireless local area networks (WLAN).

In a typical mobile system the user equipment may communicate via a station of an access system of the communications system. This station is commonly referred to as a base station, or Node B. A user equipment may be in wireless communication with two or more base stations at the same time over one or more radio channels. The wireless communication between user equipment and the base station(s) can be based on appropriate communication protocols. The network apparatus is controlled by an appropriate control arrangement commonly including a number of various control entities with different functions. Control of the access and core network sides of a communications system is typically separated.

Users of a communications system can be provided with various services. An example of the services are the so called location services (LCS). The location information provided by the location services may be used for various purposes, for example for location of a mobile telephone that has made an emergency call, for locating vehicles or given mobile subscribers for commercial purposes, for locating family members and so on. In general, any client such as a user or entity wishing to receive location information regarding another user may send a request for such information to an appropriate location service node. The location service will then process the request, obtain any required data and generate an appropriate response.

Location information may be provided based on the capabilities of network apparatus and/or user equipment. A mobile user equipment can be positioned by various different techniques. In an approach the geographically limited radio access entities and associated controllers of the communications system are utilised in production of an estimate concerning the location of the mobile user equipment. For improved accuracy of the location information the communication system may be provided with specific location measurement units (LMUs) that provide more accurate data or additional data concerning the location of a user equipment.

Location measurement units are typically used to measure various parameters of radio transmissions from a user equipment to be located. To enable the location measurement units to perform the required measurements, the location measurement units may need to be made aware of certain details of the radio channel used for communication between the user equipment and the access network. This information is in the present arrangements provided by an appropriate controller of the access network. For example, in the second generation (2G) mobile communication networks, such as the GSM, knowledge of the frequency and the time slot used by the user equipment for communication may be required so that a right user equipment may be measured at the right time by the appropriate location measurement units. In the existing implementations this information is delivered on the control plane by a Base Station Controller (BSC) of the access system to a Serving Mobile Location Center (SMLC) that controls and coordinates the location procedure. In the third generation (3G) arrangements information such as the codes used by the user equipment, frequency and/or other channel information may need to be known. The current thinking is that in 3G this information would be provided on the control plane by the Radio Network Controller (RNC).

Communication between various elements associated with location services (LCS) is required when providing location information. However, arrangements for communicating the required information from the access system to an appropriate location service entity may become cumbersome and costly, for example because of a large number of access network controllers, other possible nodes on the signalling path, location service servers and/or location measurement units need to be configured to comply with appropriate control plane standards and protocols.

The standards, on the other hand, leave certain aspects open, which may result interoperability problems. For example, it is possible that a Serving Mobile Location Center (SMLC) from a vendor cannot be connected to an access network controller of another vendor. Because of this the entire network may not necessarily be served using one location determination system.

It is noted that the problem is not limited to location services provided by means of mobile systems, but may occur in any communication environment wherein user equipment may need to be located.

### SUMMARY OF THE INVENTION

Embodiments of the present invention aim to address one or several of the above problems.

According to one embodiment, there is provided a method for locating a user equipment in a communication system. The method comprises communication on a user plane from the user equipment to a network element information that relates to a communication channel between the user equipment and a node of the communication system.

According to another embodiment, there is provided a user equipment for a communication system, comprising a radio part for communication on a user plane with a network element and a controller for processing communication on a user plane of information that relates to a communication channel to the network element.

According to another embodiment, there is provided a location services node, comprising an interface for receiving on user plane from a user equipment information that relates to a communication channel between the user equipment and a node of a communications network, and a controller for using said information in providing location information.

In more specific embodiments said information that relates to the communication channel may be communicated from the network element to at least one location measurement unit.

Said information that relates to the communication channel may be communicated on a user plane connection between the user equipment and a secure user plane location platform.

It may be ensured that the user equipment transmits on the communication channel during a measurement period. This may be provided by sending at least a dummy message on the user plane during the measurement period. Instructions may be sent to the user equipment on the user plane for commanding the user equipment to transmit during the measurement period. Appropriate action may be taken to ensure that sufficient energy is transmitted during the measurement period to enable measurements of at least one parameter of the communication channel.

Said information relating to the communication channel may comprise information relating to at least one of a wireless transmission frequency, time division of transmission slots, coding of transmission and an identity of a transmission channel.

Indication may be sent by the user equipment on the user plane that information that relates to a communication channel between the user equipment and the node of the communication system has changed.

The embodiment may enable a simple way of providing support for location methods employing network measurement equipment. No specific hardware may be needed for implementing the embodiments. The embodiments may also be used to improve interoperability. In certain embodiments it may be possible to reuse existing control plane network location measurement equipment, for example location measurement units for user plane location purposes.

### BRIEF DESCRIPTION OF DRAWINGS

For better understanding of the present invention, reference will now be made by way of example to the accompanying drawings in which:

FIG. 1 shows a communication system wherein the present invention may be embodied;

FIG. 2 illustrates the principles of a location method;

FIG. 3 is a flowchart illustrating an exemplifying embodiment; and

FIGS. 4 and 5 are signaling flowcharts illustrating various embodiments of the present invention.

### DETAILED DESCRIPTION OF THE PREFERRED EMBODIMENTS

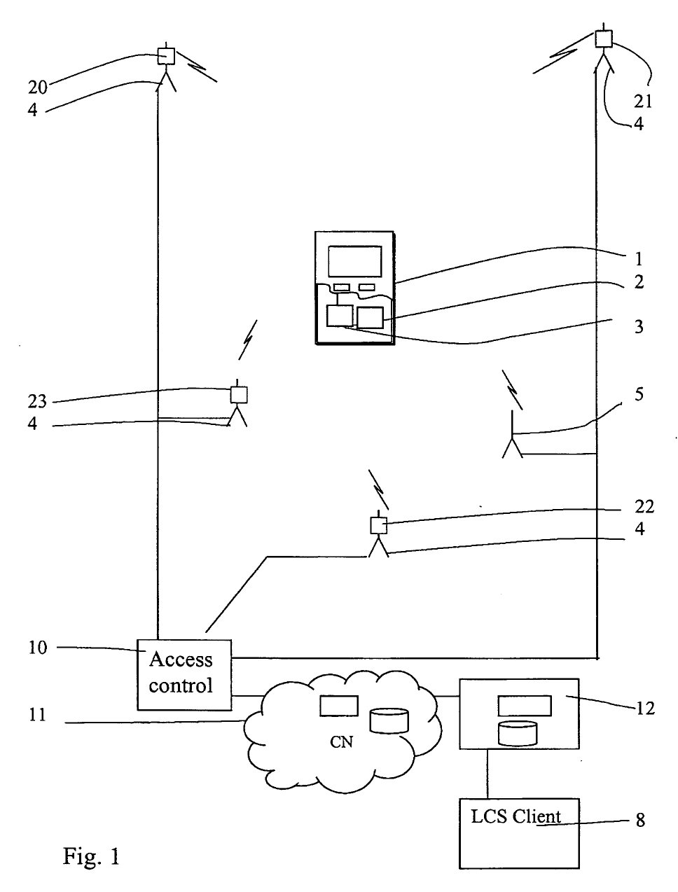

A reference is first made to FIG. 1 illustrating a communications system wherein the invention can be embodied. The underlying communications system of FIG. 1 may be provided by one mobile communication network or by a plurality of mobile and other communication networks based on different standards. The networks may be operated by one or different operators.

In a typical mobile communication network, for example the cellular public landline mobile network (PLMN), an access system is provided by means of base stations. The geographical location of each base station site 4, 5 is typically known. Each base station is arranged to wirelessly transmit signals to and receive signals from a plurality of mobile user equipment 1 (only one shown for clarity). The wireless communication between the user equipment and the base stations can be based on any appropriate communication protocol and access technology. Non-limiting examples include access based on systems such as the CDMA (Code Division Multiple Access), WCDMA (Wide-band CDMA), TDMA (Time Division Multiple Access), FDMA (Frequency Division Multiple Access), or SDMA (Space Division Multiple Access) and hybrids thereof.

The mobile user equipment 1 is able to transmit wireless signals to and receive signals from the base stations 4 and 5. An appropriate user equipment is provided with required radio part 2 comprising radio transmission elements and a controller part 3 so that it is enabled to send and receive information from the base stations, and process control instructions it may receive from or sent to the networks.

A mobile user equipment is able to move within a radio service area provided by at least one base station and also from one service area to another. In addition, a mobile user equipment may also be enabled to roam into another communication network of the mobile communication system.

In a common wireless system an access network enables the user equipment to access the core part of a communication network that links the access network to other access networks or communication networks. Each access network is typically provided with at least one controller 10 which may be connected to appropriate entities of the core network or networks. Only one access network controller 10 is shown in FIG. 1 for clarity. For example, the third generation (3G) Wideband Code Division Multiple Access (WCDMA) networks cells are controlled by control entities known as radio network controllers (RNC). In the second generation (2G) GSM (Global System for mobile) the cells of the access network are understood to be controlled by base station controllers (BSC). Typically an access network controller is connected to one of more elements of the core network 11. In FIG. 1 the core network 11 is presented as a cloud including a database and a controller for simplicity, but typically it can consist of several elements such as Serving GPRS Support Node (SGSN), Gateway GPRS Support Node (GGSN), Mobile Switching Center (MSC) and so on. FIG. 1 also shows a location services (LCS) node 12 providing location services for different applications or clients 8. The LCS client 8 can be any a logical functional entity that is allowed to make a request to the location services node, for example an appropriate server 12 for the location information of one or more target mobile stations. In general terms, the location services node 12 can be defined as an entity capable of providing information concerning the geographical location of a mobile station. For example, the geographical location can be defined on the basis of the position of the mobile station relative to the base station(s) of the mobile telecommunications network. The location service node 12 of FIG. 1 uses user plane communication for communication with the mobile user equipment 1. The location services node may consist of more than one internal elements. The location services node is shown to be beyond the core network 11 which offers a data channel towards the user equipment. For example, according to the secure user plane location (SUPL) specification, the SLP (SUPL Location Platform) may consist of two parts, namely SUPL Positioning Center (SPC) and SUPL Location Center (SLC).

Various location methods may require use of measurement equipment, or location measurement units, in the network side. With some location methods the location measurement units may measure transmissions from the base stations. Non-limiting examples of such location methods include Enhanced Observed Time Difference (E-OTD), Assisted Global Positioning System (A-GPS), and various variant of these. In some other location methods the location measurement units measure transmissions from mobile user equipment. Non-limiting examples of such location methods include Uplink Time Difference Of Arrival (U-TDOA), and Angle-Of-Arrival (AOA).

A location measurement unit (LMU) is adapted to accomplish measurements so that the location of the mobile user equipment 1 may be determined based on the measurements. Logically the location measurement units are instructed and controlled by an appropriate location services controller, for example the location services node 12 of FIG. 1. It shall be appreciated that the location measurement units may be attached to the base stations 4 utilizing their communication means. It is also possible to dispose the units in a remote location and to connect the units to the respective base station or several base stations by an appropriate communication media such as by cabling or a suitable wireless connection. It is further possible to use communication means not related to the wireless communications system for providing the communication means between the location measurement units and the location services node, for example a transport control protocol/internet protocol (TCP/IP) connection and so forth. A location measurement unit may thus be positioned either independently from a base station site or co-site with a base station. Stand-alone location measurement units may also be provided. FIG. 1 shows location measurement units (LMU) 20 to 23 in association with selected base stations 4. Base station 5 illustrates base station sites that are not provided with location measurement units.

The information received by the location service node 12 includes measurement results by location measurement units 20. The node 12 processes this information and possibly some other predefined parameters and/or computes by processor means appropriate calculations for determining and outputting the geographical location of the given mobile user equipment.

It should be appreciated that the above elements of the location service function are given as example only, and that the structure of the location information service may be different from the above described. The location information service may be implemented anywhere in the telecommunication system or in association with the telecommunication system. Functions of a location service implementation may be distributed between several elements.

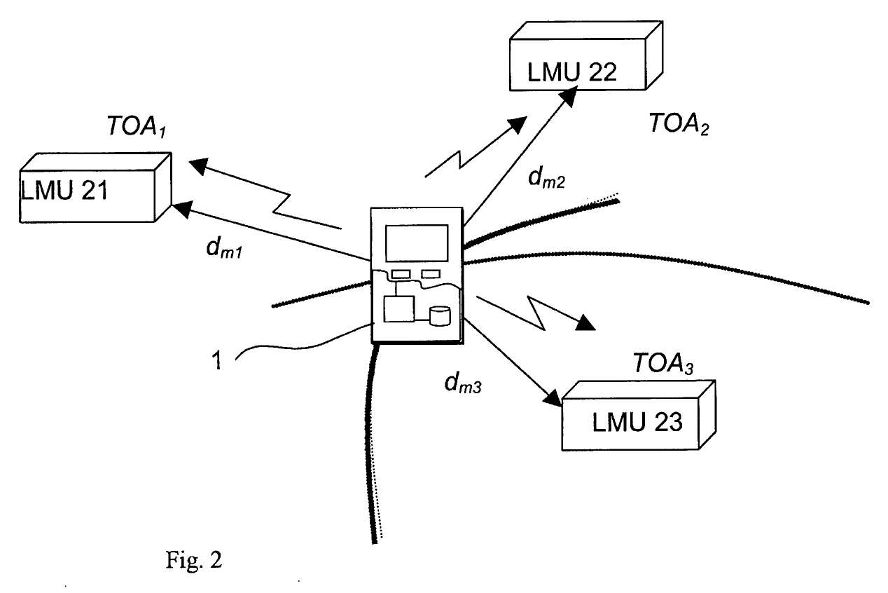

In location services that are based on the Uplink Time Difference Of Arrival (U-TDOA) location measurement units (LMU) 20 measure transmissions from a user equipment to be located. A difference between the time of arrival (TOA) values of signals may be measured by location measurement units at least at two different positions, see FIG. 2. In this example a time difference of arrival (TDOA) value can be calculated from TOA₁-TOA₂, determining a hyperbola:
c*(TOA₁−TOA₂)=dₘ₁−dₘ₂,
where c is the speed of radio waves, and
dₘ₁ and dₘ₂ denote the distance from the user equipment to location measurement units 21 and 22, respectively.

When at least two hyperbolas have been obtained, it is possible to determine the estimate of the position of the user equipment at the intersection of hyperbolas. In some cases two hyperbolas can have two intersections. It is possible for the two hyperbolas to have two intersections. Then a unique solution may require at lest one additional hyperbola, or other additional information, for example regarding the coverage area of the reference cell, may be used to select one of the intersections.

This kind of location method may require that the location measurement units are aware of certain properties of the radio signals transmitted by the user equipment in order to be able to measure the signal. The required information may relate to properties of the radio signals such as coding, timing, frequency, channel identities, and so forth, which are needed so that the correct signals are measured at right time.

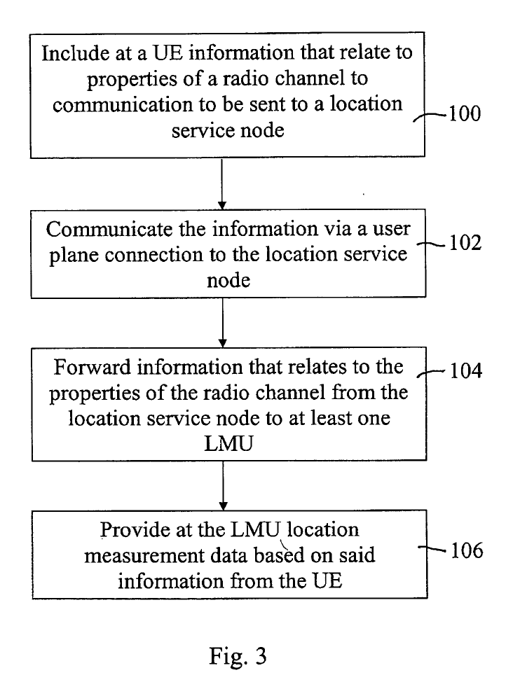

FIG. 3 illustrates an embodiment wherein, instead of providing this information from an access network controller, user equipment is actively involved in the delivery of the required details of its radio channel by including the required channel information in a user plane communication to a location service node in the network, see steps 100 and 102. The user equipment is necessarily aware of the channel information as it is required by it to be able to communicate with the base station(s). User plane address information for the location services node may be received as a part of control information received from the network. The address may also be already available in the mobile user equipment, for example as a part of the original settings or stored in response to an update message from a network. The address information may comprise, for example, an Internet Protocol (IP) address, a telephone number or other address for sending of a text message or a multimedia message, a wireless application part (WAP) address, and so on.

The network element with the user plane address may then use the information in appropriate manner, such as communicate it to the relevant location measurement units, see step 104. The location measurement unit may then perform the required measurement at step 106 based on channel information from the user equipment. Communication between the location services node and the location measurement unit may also occur on the use plane.

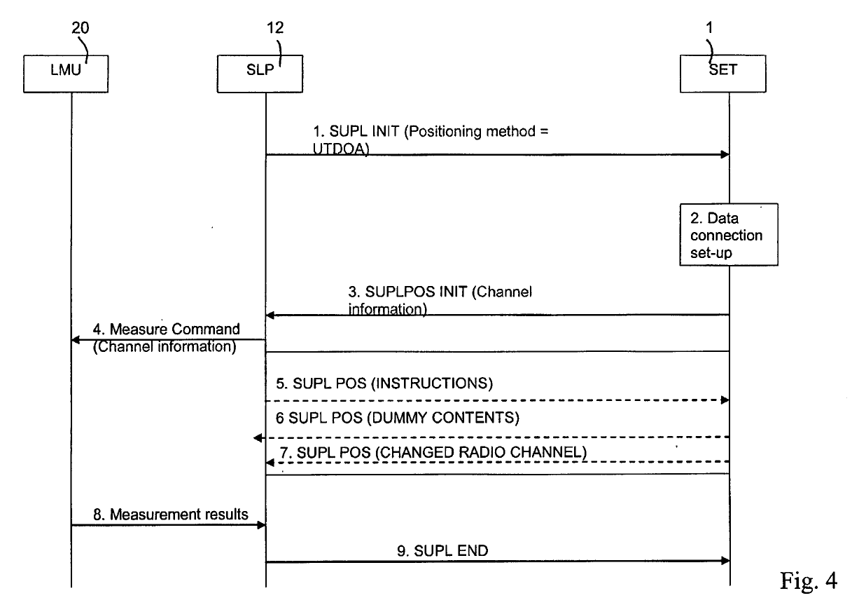

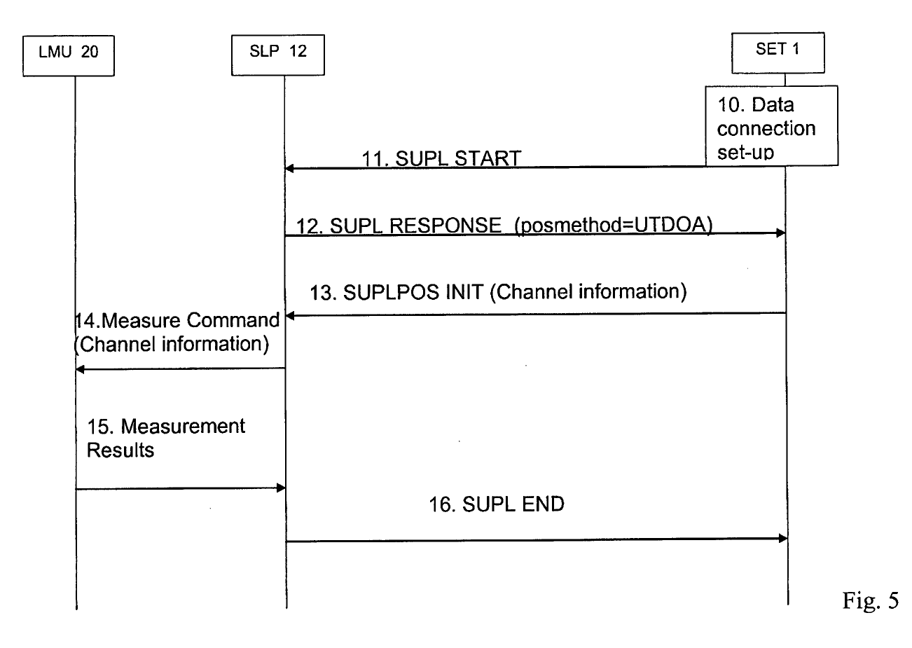

Exemplifying non-limiting embodiments of FIGS. 4 and 5 will now be explained with reference to a concept known as “Secure User Plane Location” (SUPL). The SUPL concept has been proposed in the Open Mobile Alliance (OMA) with the intention to provide a standardized architecture for use of user plane for location services. The SUPL supports location methods such as cell identity, enhanced cell identity, Enhanced Observed Time Difference (E-OTD), Advanced Forward Link Triangulation (AFLT), stand-alone Global Positioning System (GPS), Assisted Global Positioning System (A-GPS), and Observed Time Difference Of Arrival (OTDOA). It is noteworthy that these currently supported location methods are not using location measurement units that would measure transmissions from the mobile user equipment. The two exemplifying embodiments are described with reference a U-TDOA location method application running on location service nodes.

In accordance with the SUPL the location measurement units can be connected logically to the SLP. The location measurement units may be at base station sites, and even use transmission means of the site, or for example GPRS data connection. However, it is noted that this is not required in all applications.

FIG. 4 shows an exemplifying signaling flow chart for an embodiment wherein the implementation is based on the SUPL. In this case it is assumed that the location request is initiated by the network, and that the mobile user equipment or terminal is not roaming. In the SUPL direct information exchange occurs between a location services entity and a SUPL enabled user equipment. Such a user equipment is referred to in the SUPL terminology as a SUPL Enabled Terminal (SET), and the location services entity as a SUPL Location Platform (SLP).

In the beginning, a SUPL Location Platform (SLP) sends a ‘SUPL INIT’ message 1 to the mobile user equipment. This message contains a ‘Positioning Method’ information element with the value “UTDOA”. The mobile user equipment then sets up a user plane data connection at step 2 towards the SLP. The mobile user equipment may then send a ‘SUPL POS INIT’ message 3 to the SLP on the user plane. This message can be based on an existing SUPL message, but includes a new information element, called in this example ‘Channel Information’. The ‘Channel Information’information element is generated by the user equipment and contains details of at least one radio channel used by the mobile user equipment for communication towards the network.

The SLP receives the information element, and can then instruct the location measurement units (LMU) by message 4 to perform required measurements. Details of the radio channel used by the user equipment are included in this message. The SLP server may simply insert the ‘Channel Information’ information element in the message. It is also possible that the SLP sends only a part of the information in message 3 to the location measurement unit, or otherwise adapts the information in message 4 to a particular location measurement unit.

The measurement unit may then initiate the required measurements based on information of the radio channel that originates from user equipment rather than from a network element.

In certain situation is may be advantageous to ensure that the user equipment transmits data during a period when the measurements are performed by a location measurement unit. This can be ensured, for example, by sending at least one dummy message on the user plane. The sole purpose of this message may be to ensure that the user equipment transmits sufficient energy for the receiving units so that they can perform the measurements. An option is to introduce dummy content in a ‘SUPL POS’ message to ensure that the user equipment transmits sufficiently. The ‘SUPL POS’ message may contain a new dummy information element (DUMMY CONTENTS).

A new information element for instructions (INSTRUCTIONS) from the SLP to the user equipment may also be sent to force the mobile user equipment to transmit something, see message 5. These may be instruction to transmit something, or even more detailed instructions such as the number of dummy messages to be sent or the duration for sending the SUPL POS messages 6 with dummy content.

Some other existing mechanism, such as a short message, a wireless application protocol (WAP) message or so forth may also be used for this purpose.

Other new information elements can also be introduced in a SUPL POS message. For example, the user equipment may send an indication of changed radio channel details (CHANGED RADIO CHANNEL) to the location service server SLP, see message 7. This information may also be delivered in another SUPL message, for example in a modified ‘SUPL END’ message.

The location measurement units may then send the measurement results in message 8 to the SLP. The SLP may then send a ‘SUPL END’ message 9 to the user equipment to inform that the measurements are over. This message may also be used to indicate to the user equipment that it should stop sending ‘SUPL POS″’ messages with dummy content instead of e.g. a ‘SUPL POS (INSTRUCTIONS)’ message.

FIG. 5 shows another SUPL based example wherein the user equipment initiates the location determination. In step 10 a user equipment (SET) sets up a data connection towards a SLP. The user equipment then sends a ‘SUPL START’ message 11 to the SLP. This can be an existing SUPL message without any changes due to UTDOA support. The SLP may then respond with a ‘SUPL RESPONSE’ message 12. This message may contain an optional ‘posmethod’ information element with value “UTDOA”. The user equipment sends a ‘SUPL POS INIT’ message 13 to the SLP. This message includes a new information element called ‘Channel Information’ containing details of the radio channel used by the user equipment.

The SLP then sends instructions for measurements by message 14, and receives measurement results by message 15. A ‘SUPL END’ message 16 may be sent at the end to the user equipment to indicate the end of the measurements.

The required data processing functions may be provided by means of one or more data processors. Appropriately adapted computer program code product may be used for implementing the embodiments, when loaded to a computer, for example a processor of the user equipment. The program code mean may, for example, perform the generation of messages and/or information elements, interpretation of instructions and so forth. Appropriate program code means may be provided in controller 3 of user equipment 1 or in location services node 12 of the access system of FIG. 1. The program code product for providing the operation may be stored on and provided by means of a carrier medium such as a carrier disc, card or tape. A possibility is to download the program code product via a data network.

It is noted that whilst embodiments of the present invention have been described in relation to user equipment such as mobile stations, embodiments of the present invention are applicable to any other suitable type of user equipment.

The user equipment may also transport information on user plane directly to appropriate location measurement units. This requires knowledge of the user plane addresses, which may be provided by the network e.g. in appropriate control messages or be stored in the user equipment.

It is noted that even though the exemplifying embodiments shown and described in this disclosure use the terminology of the 3^{rd} generation (3G) WCDMA (Wideband Code Division Multiple Access) networks, such as UMTS (Universal Mobile Telecommunications System) or CDMA2000 public land mobile networks (PLMN) and 2G GSM, embodiments of the proposed solution can be used in any communication system wherein advantage may be obtained by means of the embodiments of the invention. The invention is not limited to wireless environments such as cellular mobile or WLAN systems either. What is required is that system level information is available for a user equipment which may then send this information to a node in the network associated with location services on user plane.

It is also noted herein that while the above describes exemplifying embodiments of the invention, there are several variations and modifications which may be made to the disclosed solution without departing from the scope of the present invention as defined in the appended claims.

1. A method for locating user equipment in a communication system, the method comprising:
communicating, on a user plane from user equipment to a network element, information that relates to a communication channel between the user equipment and a node of a communication system.

2. A method as claimed in claim 1, comprising the further step of communicating said information that relates to the communication channel from the network element to at least one location measurement unit.

3. A method as claimed in claim 1, comprising the further step of using said information in determining an uplink time difference of arrival.

4. A method as claimed in claim 1, comprising the further step of using said information in determining an angle of arrival of signals from the user equipment.

5. A method as claimed in claim 1, wherein the step of communicating said information that relates to the communication channel comprises communicating said information on a user plane connection between the user equipment and a secure user plane location platform.

6. A method as claimed in claim 1, comprising ensuring that the user equipment transmits on the communication channel during a measurement period.

7. A method as claimed in claim 6, wherein the step of ensuring comprises sending at least a dummy message on the user plane during the measurement period.

8. A method as claimed in claim 6, wherein the step of ensuring comprises sending instructions to the user equipment on the user plane for commanding the user equipment to transmit during the measurement period.

9. A method as claimed in claim 6, wherein the step of ensuring comprises ensuring that sufficient energy is transmitted during the measurement period to enable measurements of at least one parameter of the communication channel.

10. A method as claimed in claim 1, wherein said information relating to the communication channel comprises information relating to at least one of a wireless transmission frequency, time division of transmission slots, coding of transmission, and an identity of a transmission channel.

11. A method as claimed in claim 1, comprising the further step of indicating to the network element by the user equipment on the user plane that the information that relates to the communication channel between the user equipment and the node of the communication system has changed.

12. A method as claimed in claim 1, comprising the further step of receiving, at the user equipment, an address of the network element.

13. A method as claimed in claim 1, comprising the step of sending communication from the user equipment to an internet protocol address.

14. A method as claimed in claim 1, comprising the step of sending communication from the user equipment in accordance with one of a text message protocol, a multimedia message protocol, or a wireless application part protocol.

15. A method as claimed in claim 1, comprising the step of including the information at the user equipment in a message in accordance with a secure user plane location protocol.

16. A method as claimed in claim 15, wherein the message comprises a position initialisation message in accordance with a secure user plane location protocol.

17. A method as claimed in claim 1, comprising the step of sending, to the user equipment, an indication of a location method that is to be used for location of the user equipment.

18. A computer program embodied on a computer-readable medium, the computer program configured to control a processor to perform the steps of:
communicating, on a user plane, from user equipment to a network element, information that relates to a communication channel between the user equipment and a node of a communication system.

19. A user equipment, comprising:
a processor configured to communicate, on a user plane from the user equipment to a network element, information that relates to a communication channel between the user equipment and a node of a communication system.

20. A user equipment for a communication system, the user equipment comprising: a radio part for communication on a user plane with a network element and a controller to control user plane communication of information that relates to a communication channel to the network element.

21. A user equipment as claimed in claim 20, wherein the controller is configured to control sending, on the user plane, the information that relates to the communication channel.

22. A user equipment as claimed in claim 20, wherein the controller is configured to control receiving, on the user plane, the information that relates to the communication channel.

23. A location services node, comprising: an interface for receiving, on a user plane from a user equipment, information that relates to a communication channel between the user equipment and a node of a communications network, and a controller for using said information in providing location information.

24. A location services node as claimed in claim 23, wherein the controller is configured to send the information that relates to the communication channel to at least one location measurement unit.

25. A location services node as claimed in claim 23, wherein the location services node is configured in accordance with a secure user plane location protocol.

26. A system for providing location information, the system comprising:
a location services node including
an interface for receiving, on a user plane from a user equipment, information that relates to a communication channel between the user equipment and a node of a communications network, and
a controller for using said information in providing location information.
